(19) United States
(12) Patent Application Publication
(10) Pub. No.: US 2018/0051826 A1
(43) Pub. Date: Feb. 22, 2018

(54) Pipe Pulling Head

(71) Applicant: Kwon J. PARK, Diamond Bar, CA (US)

(72) Inventor: Kwon J. PARK, Diamond Bar, CA (US)

(21) Appl. No.: 15/243,016

(22) Filed: Aug. 22, 2016

(51) Int. Cl. F16L 1/032; F16L 1/06

(52) U.S. Cl. CPC F16L 1/032; F16L 1/06

(57) ABSTRACT

A pipe pulling head is provided, including first and pulling portions and a screwing portion. The engaging portion has a front end, a rear end, and an outer surface and configured for engaging and holds a first external pipe from inside of the first external pipe. The screwing portion has a front end, a rear end, and an outer surface and disposed at the front end of the engaging portion and extends coaxially and configured to be engaged and pulled by a tool such as wrench or winch. The pulling portion is provided in a central hole provided through the engaging portion and the screwing portion. The pipe pulling head is configured to be installed in the first external pipe and pulled through a second external pipe having a diameter larger than the first external pipe by the screwing portion.

### BACKGROUND OF THE INVENTION

The present invention relates to a pipe pulling head.

In plumbing, sometimes a pipe needs to be inserted into and pulled through another pipe, especially when the second pipe is buried in cement block and the like.

However, usually it is not an easy work. Sometimes, the difference of the diameters between the first and second pipes, making the problem to solve worse.

Accordingly, a need for a pipe pulling head has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a pipe pulling head.

An aspect of the invention provides a pipe pulling head, comprising a engaging portion, a screwing portion, and a pulling portion.

The engaging portion has a front end, a rear end, and an outer surface and configured for engaging and holds a first external pipe from inside of the first external pipe.

The screwing portion has a front end, a rear end, and an outer surface and disposed at the front end of the engaging portion and extends coaxially and configured to drive the engaging portion by a tool such as wrench or winch.

The pulling portion is provided in a central hole provided through the engaging portion and the screwing portion.

The pipe pulling head is configured to be installed in the first external pipe and pulled through a second external pipe having a diameter larger than the first external pipe by the pulling portion.

The engaging portion may comprise a male helical thread provided on the outer surface with a specific thread angle.

The specific thread angle may be from approximately 30 degrees to about 120 degrees. More specifically, the specific thread angle may be from approximately 45 degrees to about 60 degrees.

The specific thread angle may be determined based on a material of the first external pipe.

The male helical thread may be configured to cut into the first external pipe while engaging.

The engaging portion and the screwing portion may be made monolithically.

The engaging portion and the screwing portion may be made of hardened metal comprising stainless steel.

The pulling portion may comprise the central hole through the engaging portion and the screwing portion, and the central hole may be configured for queuing a gripping and pulling wire of an external winch device.

The gripping and pulling wire may comprise an aircraft wire or cable. The gripping and pulling wire further comprises a stopper disposed at an end of the gripping and pulling wire and configured to latch and hold the pipe pulling head at the rear end of the pipe pulling head.

The screwing portion may further comprise a hexagonal nut portion on the outer surface thereof, and the hexagonal nut portion may be configured for driving the helical thread of the engaging portion into the first external pipe.

The advantages of the present invention are: (1) the pipe pulling head according to the invention is simple in the structure, installation, usage, and maintenance; and (2) the pipe pulling head according to the present invention provides a very effective way to pull a pipe through another tight pipe.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a pipe pulling head installed at a pipe according to an embodiment of the invention;

FIG. 2 is another perspective view showing a pipe pulling head installed at a pipe, which is inserted inside another pipe according to an embodiment of the invention;

FIG. 3 is a perspective top view showing a pipe pulling head according to an embodiment of the invention;

FIG. 4 is a perspective bottom view showing a pipe pulling head according to an embodiment of the invention; and

FIG. 5 is a perspective view of a pipe pulling head with a winching wire installed according to an embodiment of the invention.

### DETAILED DESCRIPTION EMBODIMENTS OF THE INVENTION

Referring to the figures, the embodiments of the invention are described in detail.

An object of the invention is to provide a pipe pulling head, which is connected to a first pipe and pulled through a second pipe.

An aspect of the invention provides a pipe pulling head 100, comprising a engaging portion 10, a screwing portion 20, and a pulling portion 30.

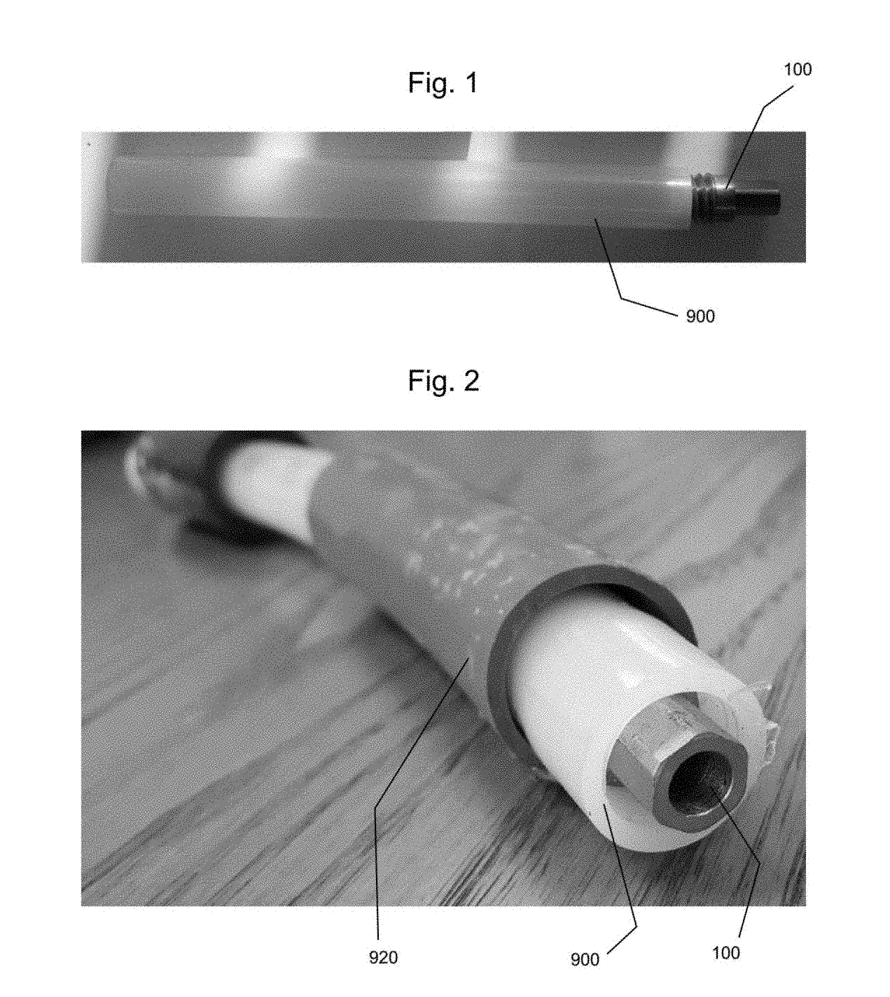

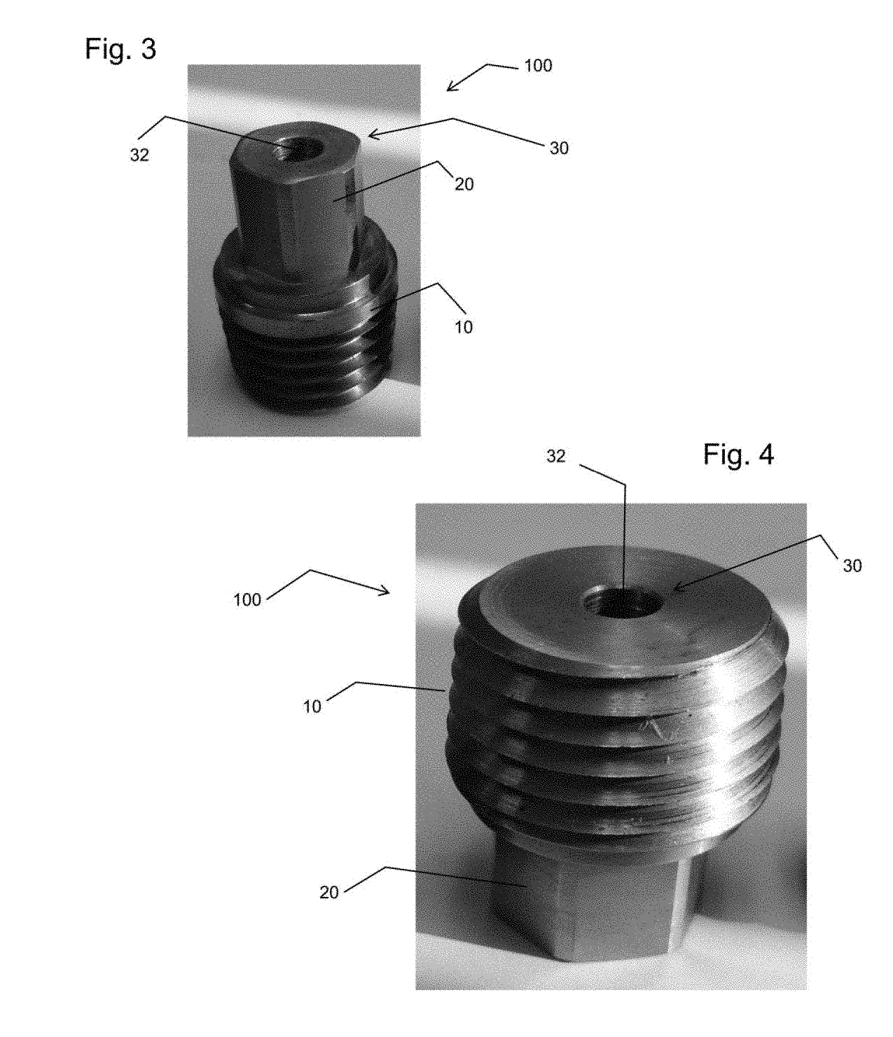

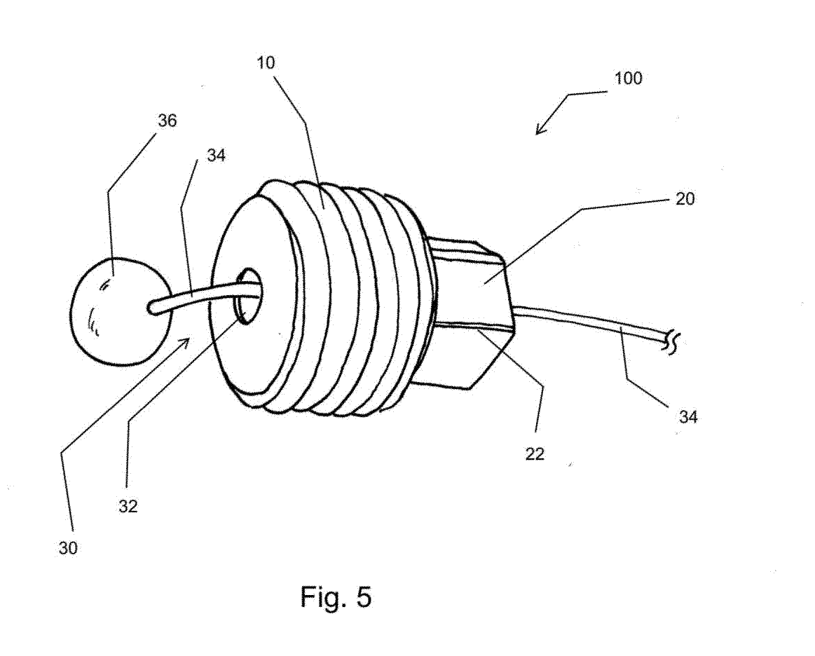

The engaging portion 10 has a front end, a rear end, and an outer surface and configured for engaging and holds a first external pipe 900 from inside of the first external pipe 900 as shown in FIGS. 1 and 2.

The screwing portion 20 has a front end, a rear end, and an outer surface and disposed at the front end of the engaging portion 10 and extends coaxially and configured to drive the engaging portion 10 into the first external pipe 900 by a tool such as wrench or winch (not shown).

The pulling portion 30 is provided in a central hole 32 provided through the engaging portion 10 and the screwing portion 20 as shown in FIG. 5.

The pipe pulling head 100 is configured to be installed in the first external pipe 900 and pulled through a second external pipe 920 having a diameter larger than the first external pipe 900 by the pulling portion 30 as shown in FIGS. 1 and 2.

The engaging portion 10 may comprise a male helical thread provided on the outer surface with a specific thread angle. The specific thread angle may be from approximately 30 degrees to about 120 degrees. More specifically, the specific thread angle may be from approximately 45 degrees to about 60 degrees. The specific thread angle may be determined based on a material of the first external pipe. The male helical thread may be configured to cut into the first external pipe 900 while engaging.

The engaging portion 10 and the screwing portion 20 may be made monolithically.

The engaging portion 10 and the screwing portion 20 may be made of hardened metal comprising stainless steel.

The pulling portion 30 may comprise the central hole 32 through the engaging portion 10 and the screwing portion 20, and the central hole 32 may be configured for queuing a gripping and pulling wire 34 of an external winch device (not shown) as shown in FIG. 5.

The gripping and pulling wire 34 may comprise an aircraft wire or cable. The gripping and pulling wire 34 further comprises a stopper 36 disposed at an end of the gripping and pulling wire 34 and configured to latch and hold the pipe pulling head 100 at the rear end of the pipe pulling head 100 as shown in FIG. 5.

The screwing portion 20 may further comprise a hexagonal nut portion 22 on the outer surface thereof, and the hexagonal nut portion 22 may be configured for driving the helical thread of the engaging portion 10 into the first external pipe 900.

A PEX pipe is used as the first external pipe 900, which has an interesting property of expanding and then shrinking to its original diameter. Therefore, the engaging portion 10 cuts into the inner surface and makes the outside bulge a little bit, but the diameter returns to its original value with time.

This invention is very useful in a sense that it enables to install the first external pipe 900 inside the second external pipe 920, without digging out the second external pipe 920.

The connecting between the engaging portion 10 and the first external pipe 900 is simple and quite strong, enabling to pull a pipe through another tight pipe without disturbing the latter pipe.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A pipe pulling head comprising:
an engaging portion having a front end, a rear end, and an outer surface and configured for engaging and holding a first external pipe from inside of the first external pipe;
a screwing portion having a front end, a rear end, and an outer surface and disposed at the front end of the engaging portion and extending coaxially and configured to drive the engaging portion by a tool such as wrench or winch; and
a pulling portion provided in a central hole provided through the engaging portion and the screwing portion,
wherein the pipe pulling head is configured to be installed in the first external pipe and pulled through a second external pipe having a diameter larger than the first external pipe by the pulling portion.

2. The pipe pulling head of claim 1, wherein the engaging portion comprises a male helical thread provided on the outer surface with a specific thread angle.

3. The pipe pulling head of claim 2, wherein the specific thread angle is from approximately 30 degrees to about 120 degrees.

4. The pipe pulling head of claim 3, wherein the specific thread angle is from approximately 45 degrees to about 60 degrees.

5. The pipe pulling head of claim 3, wherein the specific thread angle is determined based on a material of the first external pipe.

6. The pipe pulling head of claim 5, wherein the male helical thread is configured to cut into the first external pipe while engaging.

7. The pipe pulling head of claim 1, wherein the engaging portion and the screwing portion are made monolithically.

8. The pipe pulling head of claim 7, wherein the engaging portion and the screwing portion are made of hardened metal comprising stainless steel.

9. The pipe pulling head of claim 1, wherein the pulling portion comprises the central hole through the engaging portion and the screwing portion, and wherein the central hole is configured for queuing a gripping and pulling wire of an external winch device.

10. The pipe pulling head of claim 9, wherein the gripping and pulling wire comprises an aircraft wire or cable.

11. The pipe pulling head of claim 10, wherein the gripping and pulling wire further comprises a stopper disposed at an end of the gripping and pulling wire and configured to latch and hold the pipe pulling head at the rear end of the pipe pulling head.

12. The pipe pulling head of claim 1, wherein the screwing portion further comprises a hexagonal nut portion on the outer surface thereof, and wherein the hexagonal nut portion is configured for driving the helical thread of the engaging portion into the first external pipe.
